(19) United States
(12) Patent Application Publication
(10) Pub. No.: US 2018/0203596 A1
(43) Pub. Date: Jul. 19, 2018

(54) COMPUTING DEVICE WITH WINDOW REPOSITIONING PREVIEW INTERFACE

(71) Applicant: Microsoft Technology Licensing, LLC, Redmond, WA (US)

(72) Inventors: Joshua Singh Dhaliwal, Bellevue, WA (US); Isaiah Ng, Seattle, WA (US); Bryan Kim Mamaril, Seattle, WA (US)

(73) Assignee: Microsoft Technology Licensing, LLC, Redmond, WA (US)

(21) Appl. No.: 15/410,691

(22) Filed: Jan. 19, 2017

(51) Int. Cl. G06F 3/0488; G06F 3/0482; G06F 3/0484; G06F 3/0481

(52) U.S. Cl. CPC G06F 3/04883; G06F 3/0482; G06F 2203/04803; G06F 3/04817; G06F 3/04886; G06F 3/04845

(57) ABSTRACT

To address the issue of efficiently repositioning application windows, a computing system including a processor and a touch sensitive display is provided. The display may be configured to detect touch inputs from a digit or stylus, and the processor may be configured to recognize an invocation gesture, present a window repositioning preview interface for an application window, detect a preview gesture, display graphical preview of a window repositioning location in the window repositioning preview interface, receive a selection of the window repositioning location, dismiss the window repositioning preview interface, and reposition the application window to the selected window repositioning location.

### BACKGROUND

In computer-based business meetings and live data sharing a user will often simultaneously access several application windows on a computer display. Repositioning a window to a preferred location on the display allows the user to organize their windows in a way that is most convenient for them. Some modern operating systems provide users with the ability to click on an open window with a mouse and drag the window to the left or right edge of the screen, and the window snaps to dock in a position occupying half of the screen in the direction in which the user dragged it. While such window snap and dock functionality is user friendly, challenges remain in certain use contexts, as discussed below.

### SUMMARY

To address the issues discussed above, a computing device with a window repositioning preview interface is provided. The computing device may include, a touch sensitive display and a processor. The display may be configured to detect touch inputs from a digit or stylus, and the processor may be configured to recognize an invocation gesture, present a window repositioning preview interface for an application window, detect a preview gesture, display a graphical preview of a window repositioning location in the wind repositioning preview interface, receive a selection of the window repositioning location, dismiss the window repositioning preview interface, and reposition the application window to the selected window repositioning location.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a computing device with a window repositions preview interface, according to one embodiment of the present disclosure.

FIG. 2 is a schematic view of a window repositioning operation on the device of FIG. 1, showing a graphical preview of a repositioning location as reduced size images of an application window.

FIG. 3 is a schematic view of a window repositioning operation on the device of FIG. 1, showing a graphical preview of a window repositioning location using virtual buttons with icons of an application window.

FIG. 4 is a schematic view of a window repositioning operation on the device of FIG. 1, showing a touch input in a title bar and a window repositioning preview interface displayed at the location of the touch input.

FIG. 5 is a schematic view of a window repositioning operation on the device of FIG. 1, showing a touch input in an application window and a window repositioning preview interface displayed at the location of the touch input.

FIG. 6 is a schematic views of a window repositioning preview interface on the device of FIG. 1, showing a graphical preview of a window repositioning location as virtual buttons with icons of an application window.

FIG. 7 is a schematic view of a window repositioning preview interface on the device of FIG. 1, showing a graphical preview of a window repositioning location using a virtual joystick control for selection.

FIG. 8 is a schematic view of a window repositioning preview interface on the device of FIG. 1, showing a graphical preview of a window repositioning location as reduced size images in a carousel.

FIG. 9 is a schematic view of a window repositioning operation on the device f FIG. 1, showing a window reposition location on a display other than the current display.

FIG. 10 is a schematic view of a window repositioning operation on the device of FIG. 1, showing a persistently displayed selector.

FIG. 11 is a schematic view of a window repositioning operation on the device of FIG. 1, showing a selection gesture that intersects a blackboard region.

FIG. 12 is a flowchart of a method for a computing device, according to one embodiment of the present disclosure.

FIG. 13 shows an example computing system, according to an embodiment of the present disclosure.

### DETAILED DESCRIPTION

The inventors of the subject application have discovered that organizing the locations of application windows on computer displays can be tedious and time consuming. Current solutions include input from an external component, such as a keyboard or mouse, or require a user to touch and drag an application window to its desired location. While these manipulations may be suitable in some contexts, several challenges remain. For example, it takes time and extension of the user's arm to click on a window and drag it to the side of the screen. During this action, the user's mouse may transcend the boundaries of a mouse pad, and the user may experience an ergonomic burden to grab and reposition the mouse. When using a keyboard to reposition an application window, a user may fumble and erroneously hit a wrong key. Further, when such operating systems are run on large format touch screens (e.g., 42 inch or larger), such as in virtual whiteboard applications, the opposite side of the screen may be beyond the reach of the user. Manually relocating an application window by touch input can involve walking up to seven feet to the other side of the display, which is inconvenient and disruptive during a presentation. To overcome such issues, the inventors have conceived of a computing device with a window repositioning preview interface that will allow a user to preview and select a window relocation position for an application window.

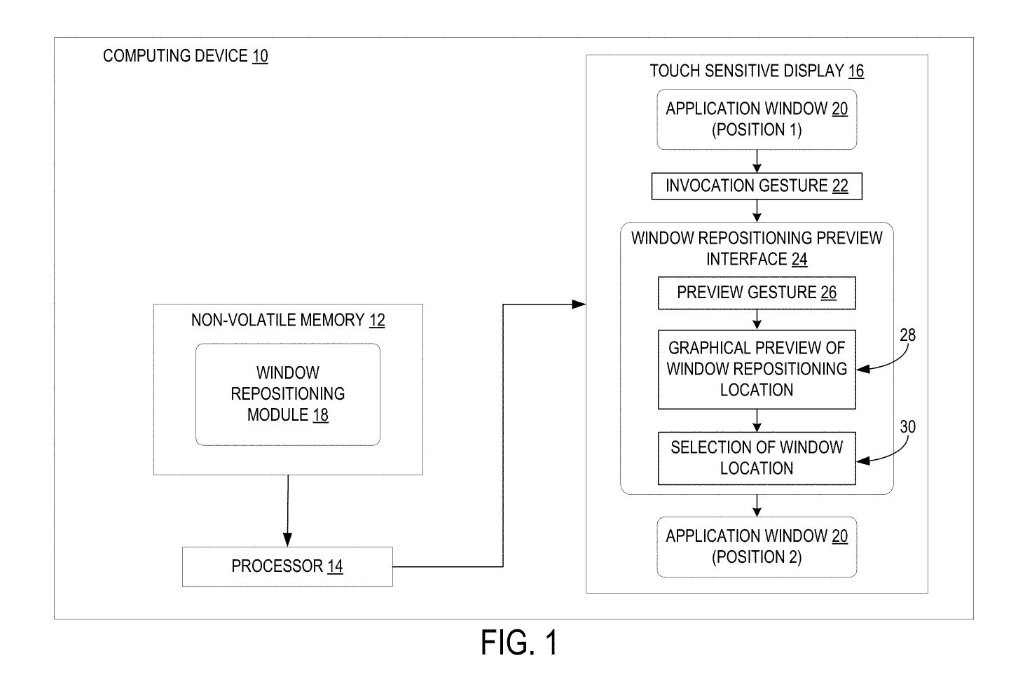

As shown in FIG. 1, to address the above identified issues a computing device 10 is provided. The computing device 10 includes non-volatile memory 12, a processor 14, and a touch sensitive display 16. The non-volatile memory 12 is configured to include a window repositioning module 18, which is executed by the processor 14 in communication with the touch sensitive display 16 having an open application window 20.

When a user desires to move the application window 20 to a new location, they may provide a touch input on the touch sensitive display 16 that is configured to detect touch inputs from a digit or a stylus. It will be appreciated that the touch input from a digit or stylus may be in the form of direct physical contact or a hover interaction sensed, for example, by a capacitive sensor of the touch sensitive display 16. The processor 14 is configured to recognize an invocation gesture 22 in a first touch input and present a window repositioning preview interface 24 for the application window 20 in response to the invocation gesture 22. The processor 14 is further configured to detect a preview gesture 26 in a second touch input. In response to the preview gesture 26, a graphical preview 28 of at least one repositioning location is displayed in the window repositioning preview interface 24. The processor 14 receives a selection 30 of the window repositioning location based on user input and, in response to the selection 30, subsequently dismisses the window repositioning preview interface 24 and repositions the application window 20 to the selected window repositioning location. In this embodiment, user input is described as touch input from a stylus or digit. However, it will be appreciated that a user may also provide input with a conventional mouse. Additionally, user input may be direct physical contact or hover interaction with touch sensitive display 16, a mouse click or a mouseover interaction.

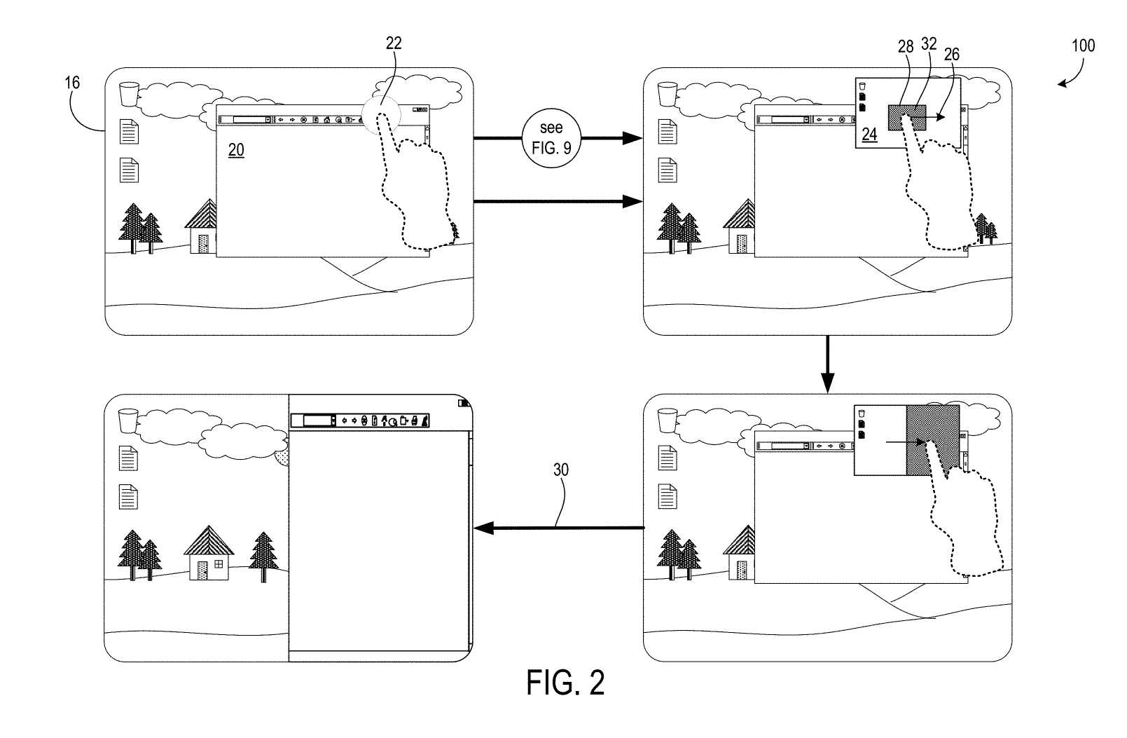

Turning now to FIG. 2, an example of a window repositioning operation 100 is shown in which the graphical preview 28 of the window repositioning location includes a reduced size image 32 of an application window 20 on the display. Beginning with the upper left panel, an invocation gesture 22 is executed in an application window 20 of a touch sensitive display 16. Proceeding in a clockwise direction to the next panel, a window repositioning preview interface 24 is displayed in the application window 20 of the touch sensitive display 16 in response to the invocation gesture 22. The window repositioning preview interface 24 may appear proximate the location of the invocation gesture 22 and represents the desktop of the touch sensitive display 16. In this embodiment, the window repositioning preview interface 24 shows a reduced size image 32 of the application window 20, as depicted by the checkered rectangle. At this point, the user may input a preview gesture 26 having a directionality to view a preview of the application window 20 in a repositioned location. Moving from the second panel to the third panel, the preview gesture 26 is executed on the reduced size image 32 in the window repositioning preview interface 24, and the graphical preview 28 of the window repositioning location is displayed. In this example, the user swipes right, resulting in a graphical preview 28 of the window repositioning location in which the reduced size image 32 of the application window position after selection is highlighted on the display to occupy the right half of the window repositioning preview interface 24. However, it will be appreciated that the preview gesture 26 may have alternative directionality, such as to the left or any of the four quadrants to preview a window repositioning location, as well as up or down to maximize or minimize the application window 20.

When selection 30 of the window relocation position has been achieved by the user, the window repositioning preview interface 24 is dismissed, and the application window 20 is repositioned to the selected location, as shown by the last panel in FIG. 2. In this example, selection 30 of the window relocation position occurs when the user lifts up and the touch input disengages from the touch sensitive display 16. However, it will be appreciated that selection 30 of the window relocation position is not limited to disengagement from the touch sensitive display 16 and can be achieved by other means, such as a double tap or inactivity of the touch input.

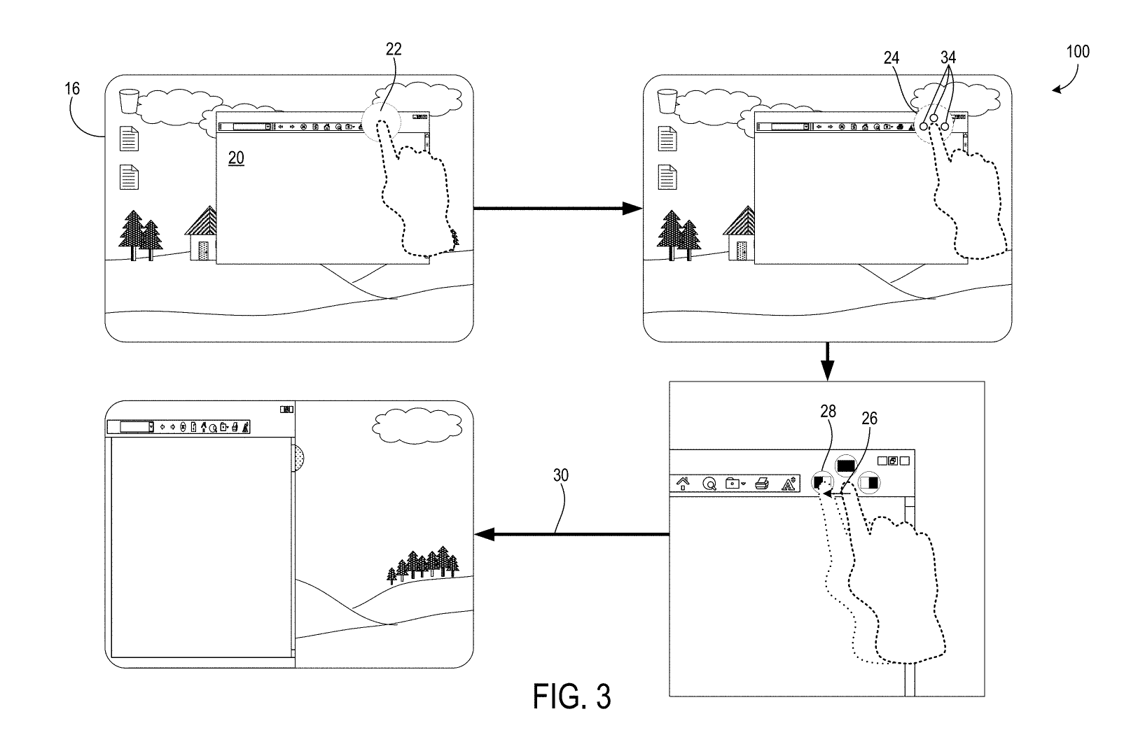

FIG. 3 illustrates another embodiment of a window repositioning operation 100. In this example, the graphical preview 28 of the window repositioning location includes virtual buttons 34 superimposed can the title bar 36 of the application window 20. Beginning with the upper left panel, a user may execute an invocation gesture 22 in an application window 20 of a touch sensitive display 16. Proceeding in a clockwise direction to the next panel, a window repositioning preview interface 24 is displayed in the application window 20 of the touch sensitive display 16 in response to the invocation gesture 22. The window repositioning preview interface 24 may appear proximate the location of the user's invocation gesture 22 and represents the desktop of the touch sensitive display 16. In this embodiment, the window repositioning preview interface 24 includes virtual buttons 34, as depicted in the second panel by circles proximate the location of the invocation gesture 22 in the first panel. While three virtual buttons 34 are provided in this example, it will be appreciated that the graphical preview 28 of window repositioning locations may include an alternate number of virtual buttons 34.

Moving from the second panel to the third panel, an enlarged image of the window repositioning preview interface 24 is provided. As shown, the graphical preview 28 of the window repositioning location includes virtual buttons 34, each button having an icon representing an application window 20 position after selection 30. A user may execute a preview gesture 26 on a virtual button 34 in the window, repositioning preview interface 24. In this example, the user swipes left to select the virtual button 34 with an icon of the application window 20 occupying the left half of the desktop of the touch sensitive display 16. While the preview gesture 26 illustrated in FIG. 3 depicts a swiping motion with directionality, it will be appreciated that a user may also invoke a graphical preview 28 of a window repositioning location by other methods, such as touching a virtual button 34 with an icon representing the desired window repositioning location.

When selection 30 of the window relocation position has been achieved by the user, the window repositioning preview interface 24 is dismissed, and the application window 20 is repositioned to the selected location, as shown by the last panel in FIG. 3. In this example, selection 30 of the window relocation position occurs when the touch input disengages from the touch sensitive display 16. However, it will be appreciated that selection 30 of the window relocation position is not limited to disengagement from the touch sensitive display 16 and can be achieved by other means, as discussed above.

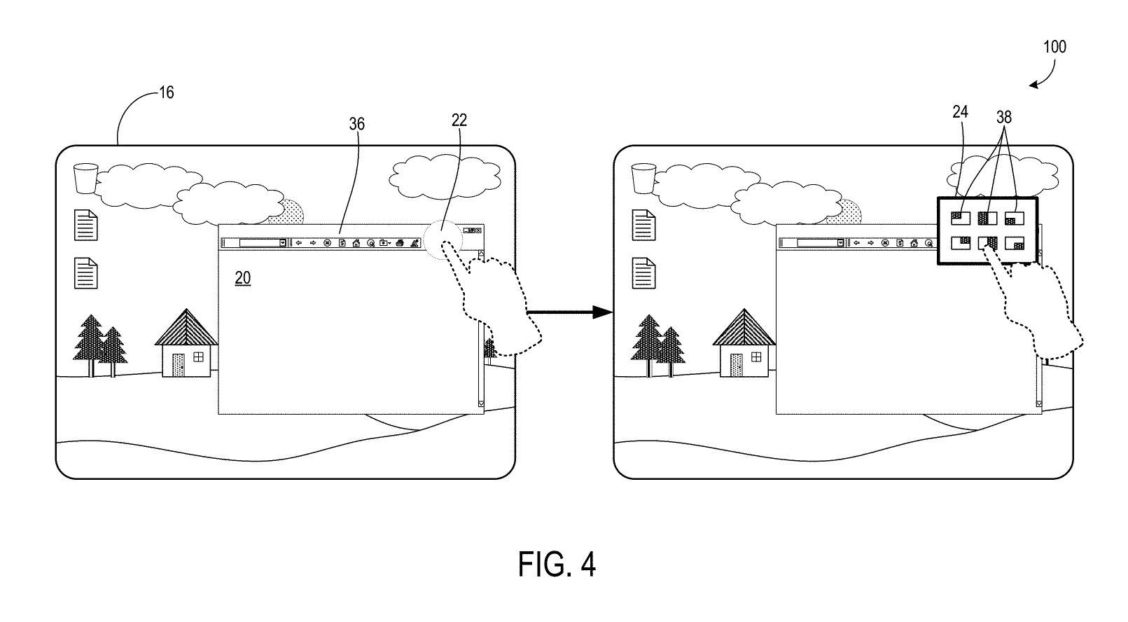

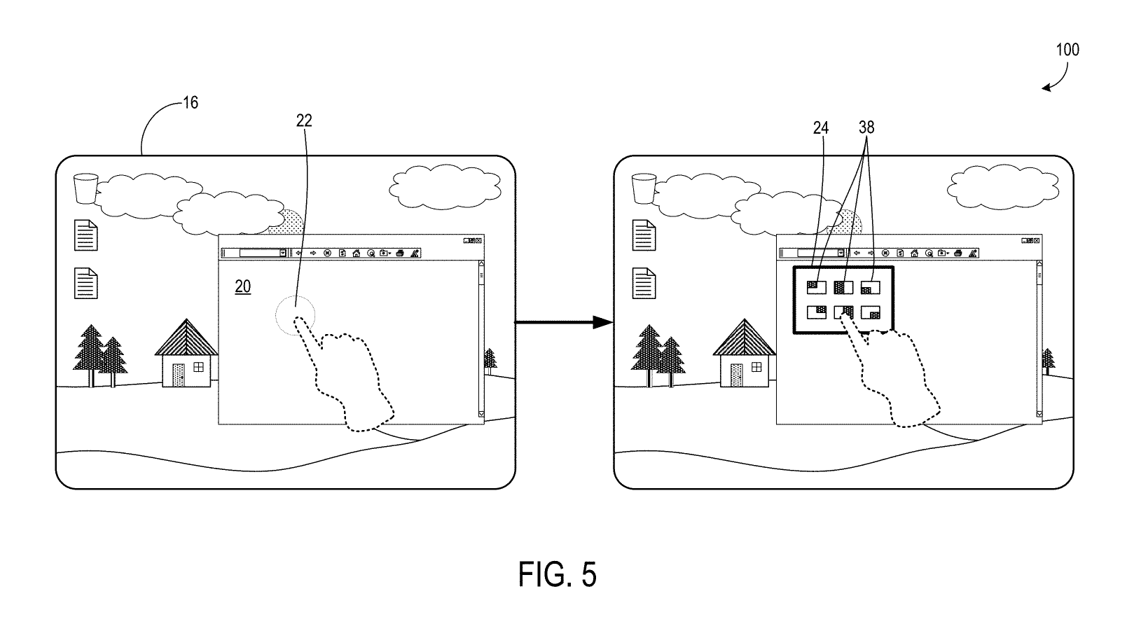

Turning to FIG. 4, another example of a window reposition operation 100 is shown. In the left panel, an invocation gesture 22 is executed in an application window 20 of a touch sensitive display 16. Proceeding to the right panel, a window repositioning preview interface 24 is displayed in the application window 20 of the touch sensitive display 16 in response to the invocation gesture 22. As with the examples shown in FIGS. 2 and 3, the window repositioning preview interface 24 may appear proximate the location of the invocation gesture 22. Furthermore, the invocation gesture 22 may be a touch input in a title bar 36 of an application window 20. While the title bar 36 of an application window 20 is an intuitive location for a user to input an invocation gesture 22, it will be appreciated that the invocation gesture 22 may occur anywhere in the application window 20. For example, FIG. 5 illustrates an invocation gesture 22 and subsequent presentation of a window relocation preview interface 24 occurring the body of the application window 20.

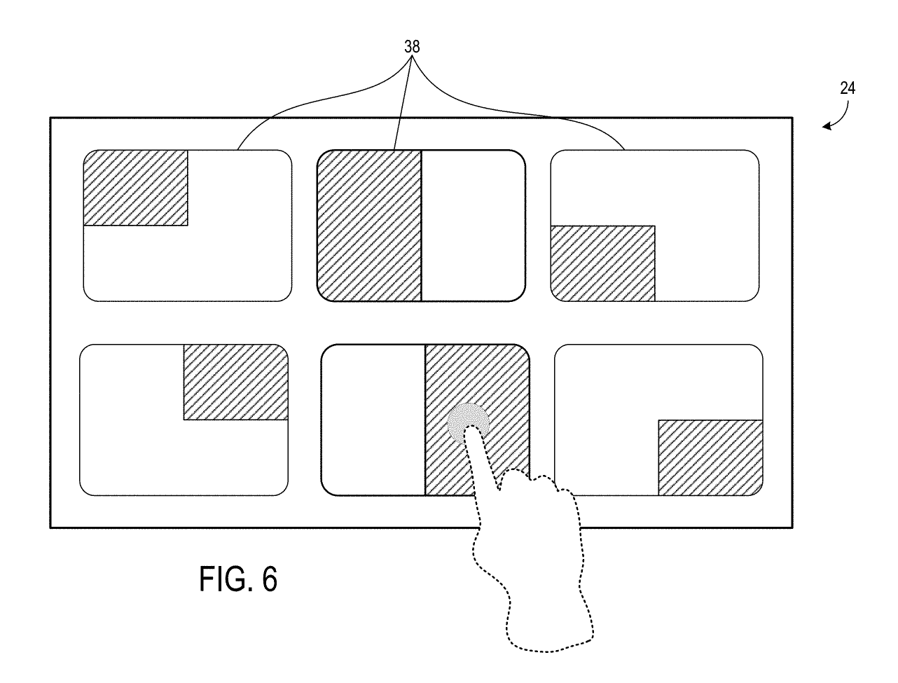

In FIGS. 4 and 5, the embodiment of the window relocation preview interface 24 shown in the right panel is depicted by a pop-up panel that includes virtual buttons 38. FIG. 6 illustrates in detail the window relocation preview interface 24 shown in FIGS. 4 and 5. In this embodiment of the window relocation preview interface 24, each virtual button 38 is an icon representing a position of an application window 20 after selection 30. As discussed above, the selection 30 of the position of the application window 20 may be executed by touching the virtual button 38 that displays the desired application window repositioning location.

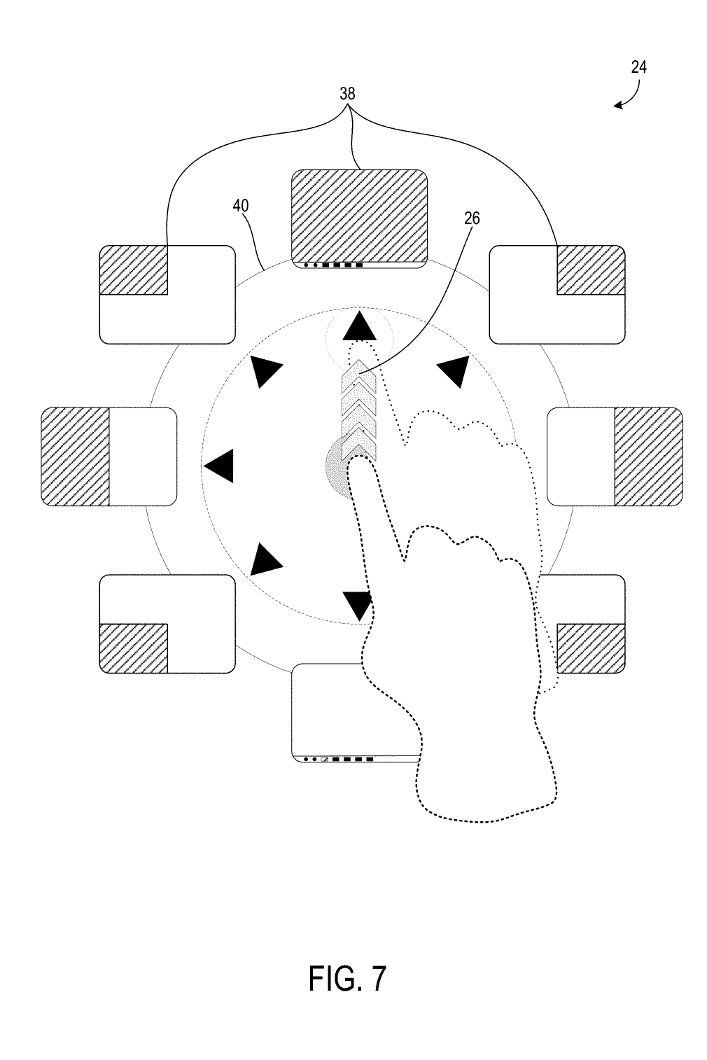

Turning to FIG. 7, another embodiment of a window relocation preview interface 24 is provided. Here, the window repositioning preview interface 24 includes a virtual joystick control 40 and may appear as a pop-up window or superimposed on the application window 20 at a position proximate the invocation gesture 22. The virtual joystick control 40 is configured to be actuated by the preview gesture 26 in the second touch input to select a window repositioning location. In the example illustrated in FIG. 7, the user inputs a preview gesture 26 with an upward directionality to select a maximized window repositioning location for the application window 20. It should be noted that a maximized mode is distinguished from a full screen mode in that the tool bar remains visible when an application window 20 is maximized, as depicted in FIG. 7. As in FIGS. 4-6, the graphical preview 28 of the window repositioning location shown in the virtual joystick control 40 in FIG. 7 includes virtual buttons 38 with icons representing the position of an application window 20 after selection 30. However, it will be appreciated that the virtual joystick control 40 may also display reduced size images 32 of an application window 20 on the display.

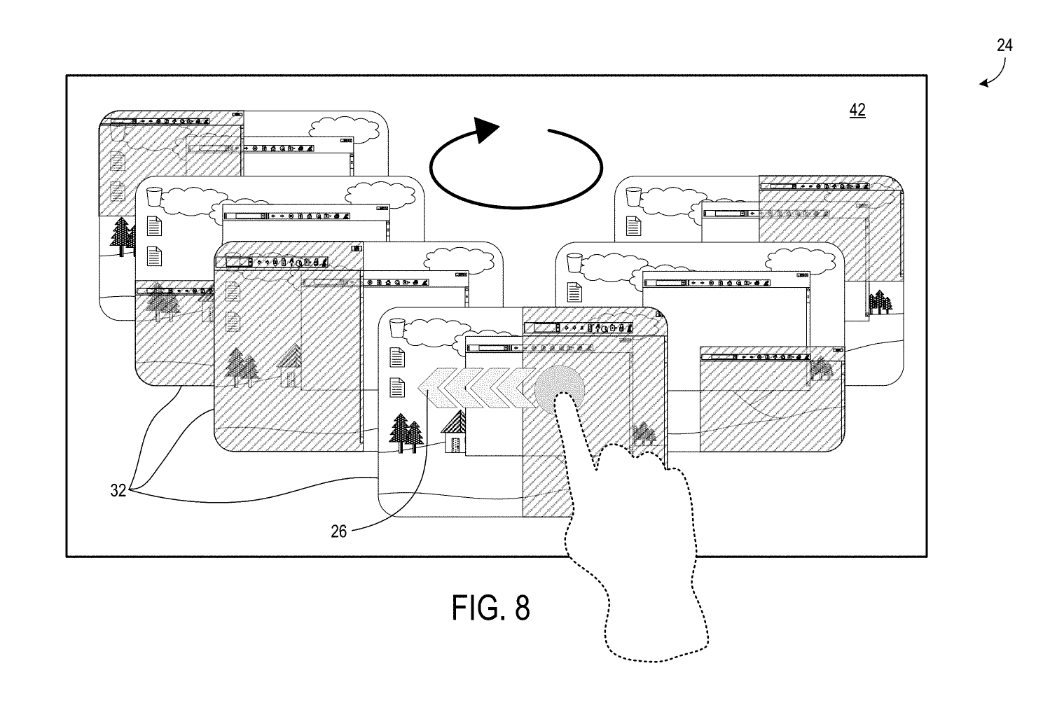

Looking now at FIG. 8, another example of a window relocation preview interface 24 is provided. In this embodiment, the window relocation preview interface 24 includes pop-up window with a carousel 42 of graphical previews 28 of window repositioning locations. The user may scroll through the graphical previews 28 to select the desired window repositioning location. While the example provided in FIG. 8 illustrates a user swiping left through reduced size images 32 of the window repositioning location, it will be appreciated that the directionality of the preview gesture 26 in this embodiment is not limited to a leftward motion. Further, the carousel 42 of graphical previews 28 may be comprised of virtual buttons 38 with icons depicting the position of an application window 20 after selection 30.

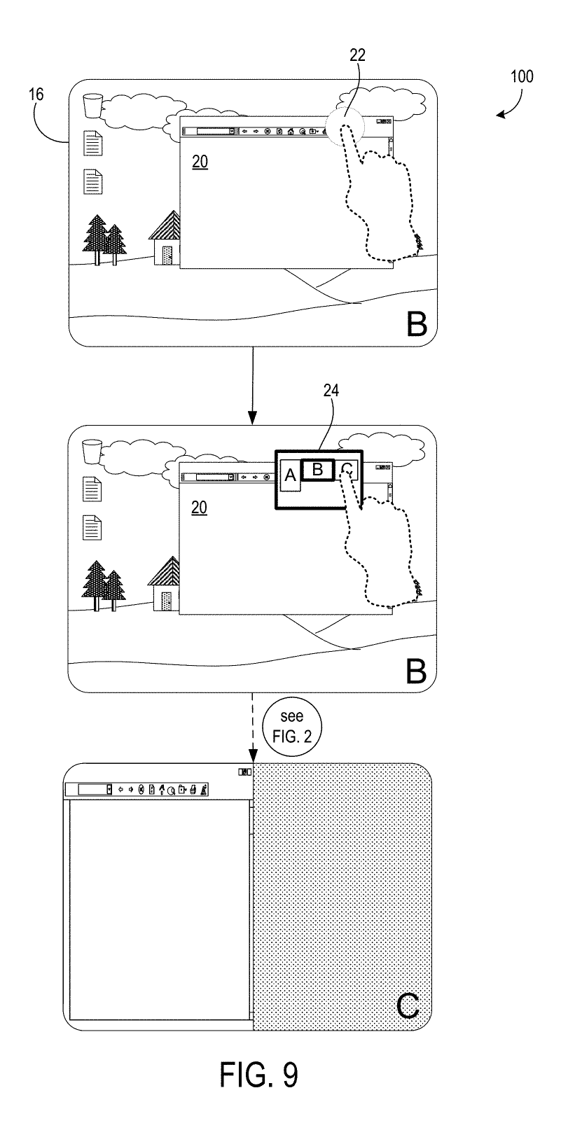

In today's world of advancing technology, it is not uncommon for a computing device to include more than one display. When working with multiple displays, a user may desire to move application windows from one display to another. It would be particularly beneficial and efficient for a user to be able to choose the location of the application window 20 on the display to which it is moved. FIG. 9 illustrates a window repositioning operation 100 in which the selected window repositioning location is on a display other than the current display. As shown in the top and center panels of FIG. 9, the, invocation gesture 22 presents a window repositioning preview interface 24 that displays previews of more than one display, depicted by the letters A, B, and C, each display having more than one window repositioning location. The user is currently engaged with display B, but may desire to move an application window 20 to display C. After selecting the desired display for the window repositioning location, the user will be presented with a graphical preview 28 of window relocation positions for completing the window repositioning operation 100, as illustrated in FIG. 2. It will be appreciated that the graphical preview 28 of the window relocation positions is not limited to the reduced size images 32 depicted in FIG. 2 and may be an alternative embodiments of graphical previews 28 as described above. When selection 30 of the window relocation position has been achieved by the user, the window repositioning preview interface 24 is dismissed, and the application window 20 is repositioned to the selected location of the selected display, as shown in the bottom panel of FIG. 9.

In any of the above-described embodiments of the window repositioning preview interface 24 that is invoked during a window repositioning operation 100, the window repositioning location may be selected from the group comprising right side, left side, upper right quadrant, lower right quadrant, upper left quadrant, lower left quadrant, maximize, minimize, and full screen.

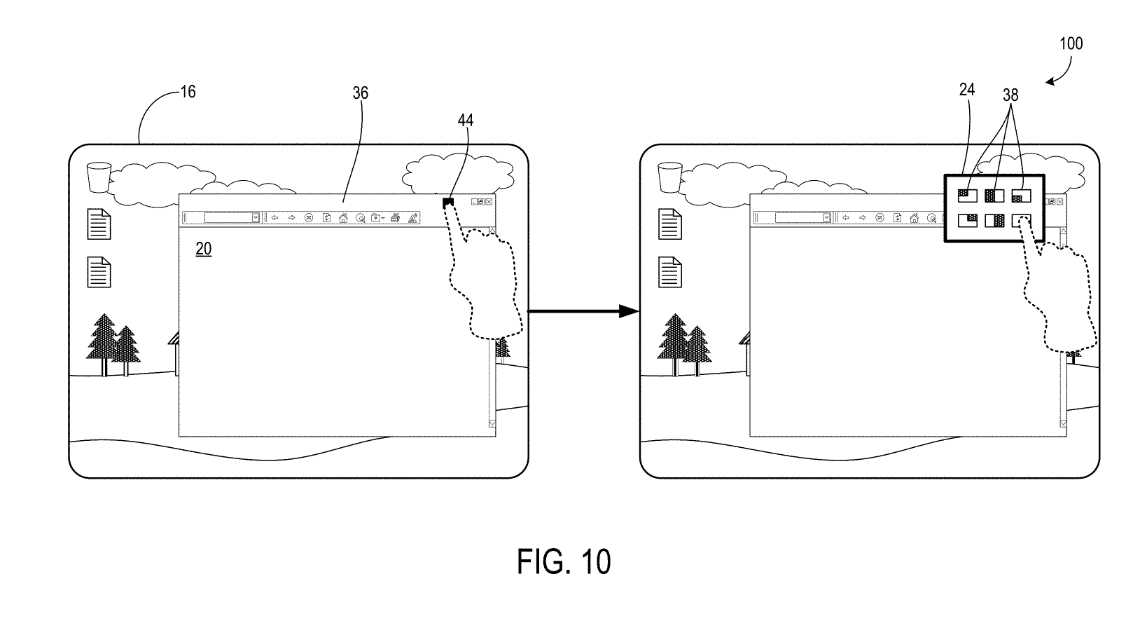

For a user who is unfamiliar or inexperienced with computing devices 10, it may be desirable to have a persistent control for the window repositioning operations 100. In such instances, a user may select a persistent mode to display a selector 44 for the window repositioning preview interface 24 persistently in the title bar 36 of the application window 20. As illustrated in FIG. 10, the selector 44 may be configured to, upon selection by a user, cause the window repositioning preview interface 24 to be displayed. Once the window repositioning preview interface 24 is displayed, the user may proceed with the window repositioning operation 100 to select a window repositioning location. While the window repositioning preview interface 24 displayed in response to selection of the selector 44 in FIG. 10 includes virtual buttons 38 with icons depicting the position of an application window 20 after selection 30, it will be appreciated that any embodiment of a window repositioning preview interface 24 described herein may be displayed in response to selection of the selector 44.

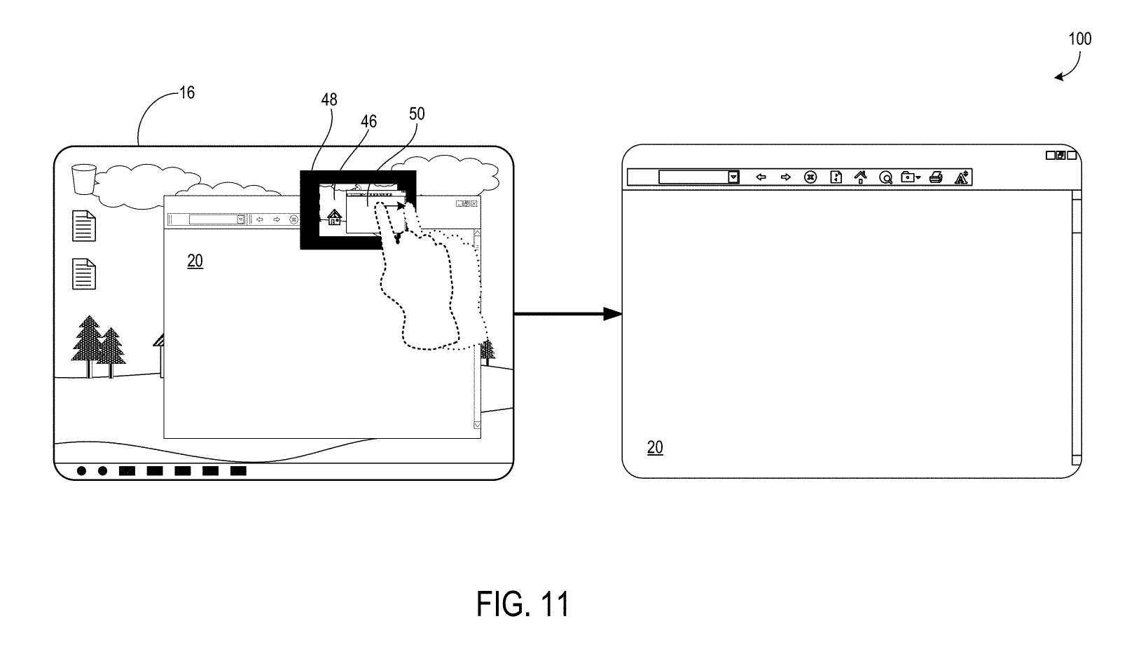

In some use case scenarios, a user may desire to view an application window 20 in full screen mode. While full screen was indicated to be one of the reposition location options in the window repositioning preview interfaces 24 described above, an additional embodiment for reposition an application window 20 to full screen mode is provided in FIG 11. In this example, the window repositioning preview interface 24 comprises a preview of a wallpaper region 46 of the display surrounded by a blackboard region 48. Within the window repositioning preview interface 24, the user may touch and drag an icon 50 for the application window 20 into the blackboard region, as shown in the left panel of FIG. 11. The window repositioning location is selected to be full screen when the directionality and magnitude (i.e., length) of the selection gesture is determined to intersect the blackboard region 48 displayed in the preview, as depicted in the right panel of FIG. 11. As discussed above, full screen mode is different from maximized window that the tool bar is still visible when an application window 20 is maximized. In the right panel of FIG. 11, no tool bar is present, thus indicating that the window repositioning location is full screen. In this example the magnitude of the selection gesture has been described as being considered. It will be appreciated that in the other examples discussed herein, the directionality as well as the magnitude (i.e. length) of the gesture may be considered. Further the position of the termination of the selection gesture (i.e., the digit up location) may be considered when determining what is selected by the selection gesture in this and other examples. Thus, when the selection gesture of FIG. 11 terminates in a digit up location that intersects the blackboard region, the selection of the full screen mode may be determined.

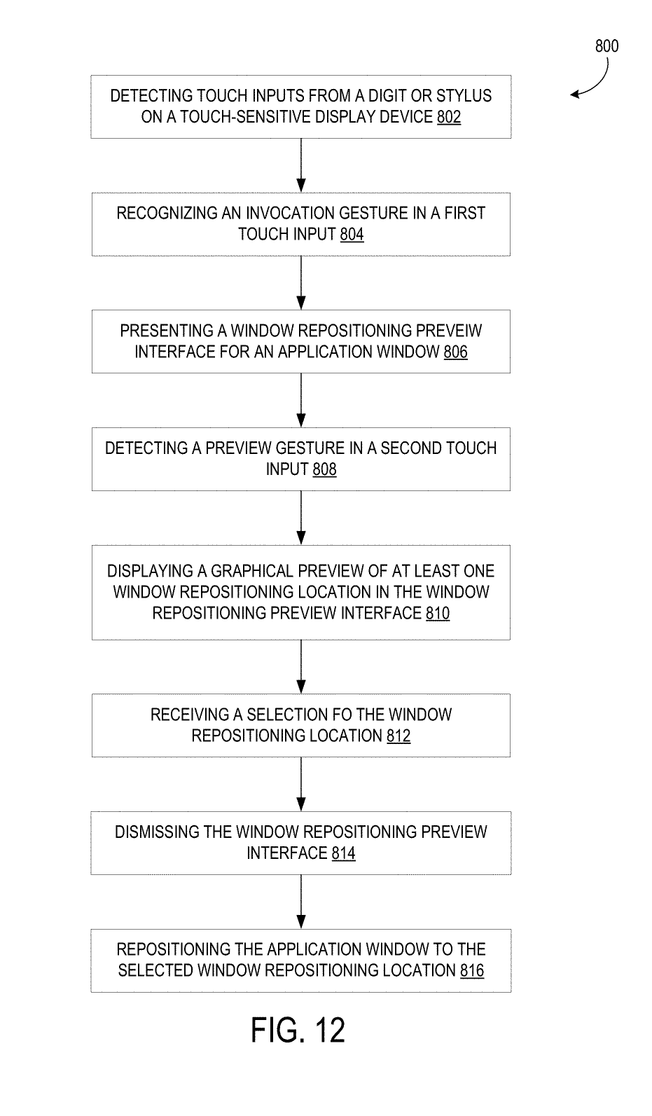

FIG. 12 shows an example method 800 according to an embodiment of the present description. Method 800 may be implemented on the computing device 10 described above or on other suitable computer hardware. At step 802, the method 800 may include detecting touch inputs on the display. As described above, the touch inputs may originate from a digit or stylus.

Proceeding from step 802 to 804, the method may include recognizing an invocation gesture in a first touch input. While it may occur anywhere in the application window, the invocation gesture is preferably a touch input in a title bar of the application window. This location is most intuitive to a user as it corresponds to current computing procedures. Advancing from step 804 to 806, the method may include presenting a window, repositioning preview interface for an application window in response to the invocation gesture. At this step, the window repositioning preview interface may appear proximate the location of the invocation gesture. As the user has already engaged the display, it is most efficient for the interface to appear in the same location as the invocation gesture. This is especially true in use case scenarios involving large screen displays in which it is preferable for the user to manipulate the location of application windows without having to walk several feet and/or obscure the information displayed on the screen. Alternatively, the computing device may be configured to display a selector persistently in the application window, the selector being configured to, upon selection by a user, cause the window repositioning preview interface to be displayed.

Progressing from step 806 to 808, the method may include detecting a preview gesture in a second touch input. In this step, the preview gesture may have a directionality. For example, the user may slide a digit or stylus to the right to indicate that the desired window repositioning location is on the right side of the display. The preview gesture may also have a magnitude (length) in addition to the directionality, and may also have a digit up location at its termination, and these may also form the basis for determining what is selected by the preview gesture. In one example, the preview gesture may be a swipe to allow the user to scroll through previews of various window repositioning locations.

Continuing from step 808 to 810, the method may include, in response to the preview gesture, displaying a graphical preview of at least one window repositioning location in the window repositioning preview interface. The graphical preview of the window repositioning location may be based upon the detected directionality of the preview gesture, among other factors.

The graphical preview of the window repositioning location may take one of several forms. For example, the graphical preview may include at least one reduced size image of an application window position after selection, highlighted on the display. In another embodiment, the graphical preview of the window repositioning location may include at least one virtual button with an icon depicting an application window position after selection. Further, the window repositioning preview interface may include a virtual joystick control, the virtual joystick control being configured to be actuated by the preview gesture in the second touch input to select a window repositioning location. In use case scenarios in which the computing device is connected to multiple display screens, the window repositioning preview interface may display previews of more than one display, each display having more than one window repositioning location, and the selected window repositioning location is on a display other than the current display.

Advancing from step 810 to 812, the method may include receiving a selection of the window repositioning location. At this step, the window repositioning location is selected from the group comprising right side, left side, upper right quadrant, lower right quadrant, upper left quadrant, lower left quadrant, maximize, minimize, and full screen. In another embodiment, the window repositioning preview interface may comprise a preview of a wallpaper region of the display surrounded by a blackboard region, and the window repositioning location is selected to be full screen when the directionality, magnitude and/or digit up location of the selection gesture is determined to intersect the blackboard region displayed in the preview.

Proceeding from step 812 to 814, the method may include, in response to the selection of the window repositioning location, dismissing the window repositioning preview interface. Typically, selection of the window relocation position occurs when the user lifts up and the touch input disengages from the touch sensitive display. However, selection of the window relocation position may be achieved by other means, such as a double tap or inactivity of the touch input.

Progressing from step 814 to 816, the method may include repositioning the application window to the selected window repositioning location. At this step, the user has completed the desired window repositioning operation 100.

It will be appreciated that the method steps described above may be performed using the algorithmic processes described throughout this disclosure, including in the description of the computing device 10 above.

In some embodiments, the methods and processes described herein may be tied to a computing system of one or more computing devices. In particular, such methods and processes may be implemented as a computer-application program or service, an application-programming interface (API), a library, and/or other computer-program product.

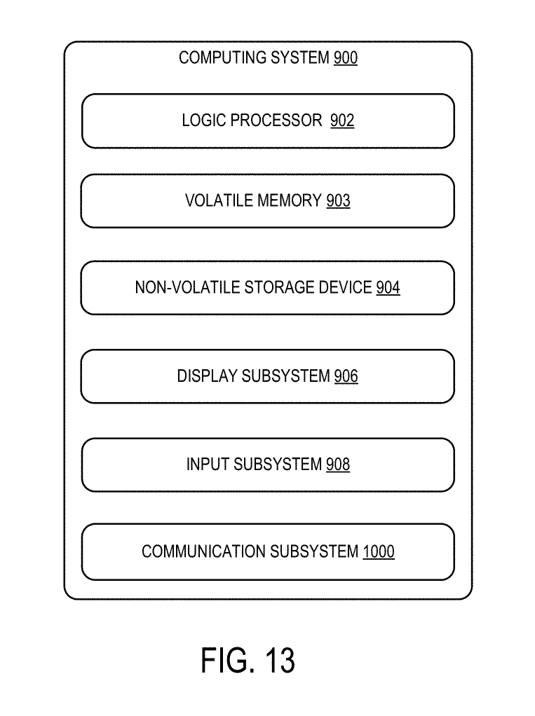

FIG. 13 schematically shows a non-limiting embodiment of a computing system 900 that can enact one or more of the methods and processes described above. Computing system 900 is shown in simplified form. Computing system 900 may embody the computing device 10 for example. Computing system 900 may take the form of one or more personal computers, server computers, tablet computers, home-entertainment computers, network computing devices, devices, mobile computing devices, mobile communication devices (e.g., smart phone), and/or other computing devices, and wearable computing devices such as smart wristwatches and head-mounted augmented reality devices.

Computing ystem 900 includes a logic processor 902, volatile memory 903, and a non-volatile storage device 904. Computing system 900 may optionally include a display subsystem 906, input subsystem 908, communication subsystem 1000, and/or other components not shown in FIG. 13.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 904 includes one or more physical devices configured to hold instructions executable by the logic processors to implement the methods and processes described herein. When such methods and processes are implemented, the state of non-volatile storage device 904 may be transformed—e.g., to hold different data.

Non-volatile storage device 904 may include physical devices that are removable and/or built-in, Non-volatile storage device 904 may include optical memory (e.g., CD, DVD, HD-DVD, Blu-Ray Disc, etc.), semiconductor memory (e.g., ROM, EPROM, EEPROM, FLASH memory, etc.), and/or magnetic memory hard-disk drive, floppy-disk drive, tape drive, MRAM, etc.), or other mass storage device technology. Non-volatile storage device 904 may include nonvolatile, dynamic, static, read/write, read-only, sequential-access, location-addressable, file-addressable, and/or content-addressable devices. It will be appreciated that non-volatile storage device 904 is configured to hold instructions even when power is cut to the non-volatile storage device 904.

Volatile memory 903 may include physical devices that include random access memory. It will be appreciated that random access memory may also be provided in non-volatile memory. Volatile memory 903 is typically utilized by logic processor 902 to temporarily store information during processing of software instructions. It will be appreciated that volatile memory 903 typically does not continue to store instructions when power is cut to the volatile memory 903.

Aspects of logic processor 902, volatile memory 903, and non-volatile storage device 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program, ” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 904, using portions of volatile memory 903. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 906 may be used to present a visual representation of data held by non-volatile storage device 904. The visual representation may take the form of a graphical user interface (GUI). As the herein described methods and processes change the data held by the non-volatile storage device, and thus transform the state of the non-volatile storage device, the state of display subsystem 906 may likewise be transformed to visually represent changes in the underlying data. Display subsystem 906 may include one or more display devices utilizing virtually any type of technology. Such display devices may be combined with logic processor 902, volatile memory 903, and/or non-volatile storage device 904 in a shared enclosure, or such display devices may be peripheral display devices.

When included, input subsystem 908 may comprise or interface with one or more user-input devices such as a keyboard, mouse, touch screen, microphone, camera, or game controller.

When included, communication subsystem 1000 may be configured to communicatively couple various computing devices described herein with each other, and with other devices. Communication subsystem 1000 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

The following paragraphs provide additional support for the claims of the subject application. One aspect provides a computing device comprising a touch sensitive display and a processor. The touch sensitive display may be configured to detect touch inputs from a digit or stylus. The processor may be configured to recognize an invocation gesture in a first touch input, present a window repositioning preview interface for an application window in response invocation gesture, detect a preview gesture in a second touch input, the preview gesture having a directionality, in response to the preview gesture, display in the window repositioning preview interface a graphical preview of at least one window repositioning location based upon the detected directionality of the preview gesture, receive a selection of the window repositioning location, and, in response to the selection, dismiss the window repositioning preview interface and reposition the application window to the selected window repositioning location. In this aspect, additionally or alternatively, the window repositioning preview interface may appear proximate the location of the invocation gesture. In this aspect, additionally or alternatively, the invocation gesture may be a touch input in a title bar of the application window. In this aspect, additionally or alternatively, the graphical preview of the window repositioning location may include at least one reduced size image of an application window position after selection, highlighted on the display. In this aspect, additionally or alternatively, the graphical preview of the window repositioning location may include at least one virtual button with an icon depicting an application window position after selection. In this aspect, additionally or alternatively, the window repositioning preview interface may include a virtual joystick control, the virtual joystick control being configured to be actuated by the preview gesture in the second touch input to select a window repositioning location. In this aspect, additionally or alternatively, the window repositioning location may be selected from the group comprising right side, left side, upper right quadrant, lower right quadrant, upper left quadrant, lowerleft quadrant, maximize, minimize, and full screen. In this aspect, additionally or alternatively, the window repositioning preview interface may display previews of more than one display, each display having more than one window repositioning location, and the selected window repositioning location may be on a display other than the current display. In this aspect, additionally or alternatively, the processor may be further configured to display a selector persistently in the application window, the selector being configured to, upon selection by a user; cause the window repositioning preview interface to be displayed. In this aspect, additionally or alternatively, the window repositioning preview interface may comprise a preview of a wallpaper region of the display surrounded by a blackboard region, and the window repositioning location may be selected to be full screen when the directionality of the selection gesture is determined to intersect the blackboard region displayed in the preview.

Another aspect provides a method for a computing device, a touch sensitive display, and a processor, comprising detecting touch inputs on the display from a digit or stylus, recognizing an invocation gesture in a first touch input, presenting a window repositioning preview interface for an application window in response to the invocation gesture, detecting a preview gesture in a second touch input, the preview gesture having a directionality, in response to the preview gesture, displaying in the window repositioning preview interface a graphical preview of at least one window repositioning location based upon the detected directionality of the preview gesture, receiving a selection of the window repositioning location, and, in response to the selection, dismissing the window repositioning preview interface and repositioning the application window to the selected window repositioning location. In this aspect, additionally or alternatively, the window positioning preview interface may appear proximate the location of the invocation gesture. In this aspect, additionally or alternatively, the invocation gesture may be a touch input in a title bar of the application window. In this aspect, additionally or alternatively, the graphical preview of the window repositioning location may include at least one reduced size image of an application window position after selection, highlighted on the display. In this aspect, additionally or alternatively, the graphical preview of the window repositioning location may include at least one virtual button with an icon depicting an application window position after selection. In this aspect, additionally or alternatively, the window repositioning preview interface may include a virtual joystick control, the virtual joystick control being configured to actuated by the preview gesture in the second touch input to select a window repositioning location. In this aspect, additionally or alternatively, the window repositioning location may be selected from the group comprising right side, left side, upper right quadrant, lower right quadrant, upper left quadrant, lower left quadrant, maximize, minimize, and full screen his aspect, additionally or alternatively, the window repositioning preview interface may display previews of more than one display, each display having more than one window repositioning location, and the selected window repositioning location may be on a display other than the current display. In this aspect, additionally or alternatively, the processor may be further configured to display a selector persistently in the application window, the selector being configured to, upon selection by a user, cause the window repositioning preview interface to be displayed.

Another aspect provides a computing device comprising a touch sensitive display and a processor. The touch sensitive display may be configured to detect touch inputs from a digit or stylus. The processor may be configured to recognize an invocation gesture in a first touch input in a title bar of an application window, present a window repositioning preview interface for an application window in response to the invocation gesture, the window repositioning preview interface appearing proximate the location of the invocation gesture, detect a preview gesture in a second touch input, in response to the preview gesture, display in the window repositioning preview interface, a graphical preview of at least one window repositioning location based upon the preview gesture, receive a selection of the window repositioning location, and in response to the selection, dismiss the window repositioning preview interface and reposition the application window to the selected window repositioning location.

It will be understood that the configurations and/or approaches described herein are exemplary in nature, and that these specific embodiments or examples are not to be considered in limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub combinations of the various processes, systems and configurations, and other features, functions, acts, and/or properties disclosed herein, as well as any and all equivalents thereof.

1. A computing device, comprising:
a touch sensitive display configured to detect touch inputs from a digit or stylus;
a processor configured to:
recognize an invocation gesture in a first touch input;
present a window repositioning preview interface for an application window in response to the invocation gesture;
detect a preview gesture in a second touch input, the preview gesture having a directionality;
in response to the preview gesture, displaying the window repositioning preview interface, a graphical preview of at least one window repositioning location based upon the detected directionality of the preview gesture;
receive a selection of the window repositioning location; and
in response to the selection,
dismiss the window positioning preview interface; and
reposition the application window to the selected window repositioning location.

2. The computing device of claim 1, wherein the window repositioning preview interface appears proximate the location of the invocation gesture.

3. The computing device of claim 1, wherein the invocation gesture is a touch input in a title bar of the application window.

4. The computing device of claim 1, wherein the graphical preview of the window repositioning location includes at least one reduced size image of an application window position after selection, highlighted on the display.

5. The computing device of claim 1, wherein the graphical preview of the window repositioning location includes at least one virtual button with an icon depicting an application window position after selection.

6. The computing device of claim 1, wherein
the window repositioning preview interface includes a virtual joystick control, the virtual joystick control being configured to be actuated by the preview gesture in the second touch input to select a window repositioning location.

7. The computing device of claim 1, wherein the window repositioning location is selected from the group comprising right side, left side, upper right quadrant, lower right quadrant, upper left quadrant, lower left, quadrant, maximize, minimize, and full screen.

8. The computing device of claim 1, wherein
the window repositioning preview interface displays previews of more than one display, each display having more than one window repositioning location, and
the selected window repositioning location is on a display other than the current display.

9. The computing device of claim 1, wherein the processor is further configured to display a selector persistently in the application window, the selector being configured to, upon selection by a user, cause the window repositioning preview interface to be displayed.

10. The computing device of claim 1, wherein
the window repositioning preview interface comprises a preview of a wallpaper region of the display surrounded by a blackboard region, and
the window repositioning location is selected to be full screen when the directionality of the selection gesture is determined to intersect the blackboard region displayed in the preview.

11. A method for a computing device, a touch sensitive display, and a processor, the method comprising:
detecting touch inputs on the display from a digit or stylus;
recognizing invocation gesture in a first touch input;
presenting a window repositioning preview interface for an application window in response to the invocation gesture;
detecting a preview gesture in a second touch input, the preview gesture having a directionality;
in response to the preview gesture, displaying in the window repositioning preview interface, a graphical preview of at least one window repositioning location based upon the detected directionality of the preview gesture;
receiving a selection of the window repositioning location; and
in response to the selection,
dismissing the window repositioning preview interface; and
repositioning the application window to the selected window repositioning location.

12. The method of claim 11, wherein the window repositioning preview interface appears proximate the location of the invocation gesture.

13. The method of claim 11, wherein the invocation gesture is a touch input a title bar of the application window.

14. The method of claim 11, wherein the graphical preview of the window repositioning location includes at least one reduced size image of an application window position after selection, highlighted on the display.

15. The method of claim 11, wherein the graphical preview of the window repositioning location includes at least one virtual button with an icon depicting an application window position after selection.

16. The method of claim 11, wherein
the window repositioning preview interface includes a virtual joystick control, the virtual joystick control being configured to be actuated by the preview gesture in the second touch input to select a window repositioning location.

17. The method of claim 11, wherein the window repositioning location is selected from the group comprising right side, left side, upper right quadrant, lower right quadrant, upper left quadrant, lower left quadrant, maximize, minimize, and full screen.

18. The method of claim 11, wherein
the window repositioning preview interface displays previews of more than one display, each display having more than one window repositioning location, and
the selected window repositioning location is on a display other than the current display.

19. The method of claim 11, wherein the processor is further configured to display a selector persistently in the application window, the selector being configured to, upon selection by a user, cause the window repositioning preview interface to be displayed.

20. A computing device, comprising:
a touch sensitive display configured to detect touch inputs from a digit or stylus;
a processor configured to:
recognize an invocation gesture in a first touch input in a title bar of an application window;
present a window repositioning preview interface application window in response to the invocation gesture, the window repositioning preview interface appearing proximate the location of the invocation gesture;
detect a preview gesture in a second touch input;
in response to the preview gesture, display in the window repositioning preview interface, a graphical preview of at least one window repositioning location based upon the preview gesture;
receive a selection of the window repositioning location; and
in response to the selection,
dismiss the window repositioning preview interface; and
reposition the application window to the selected repositioning location.
